(19) United States
(12) Patent Application Publication
(10) Pub. No.: US 2012/0010317 A1
(43) Pub. Date: Jan. 12, 2012

(54) (METH)ACRYLATE POLYMERS AND THE USE THEREOF AS POLYMER-BOUND UV INITIATORS OR ADDITIVE TO UV-CURABLE RESINS

(75) Inventors: Gerold Schmitt, Aschaffenburg (DE); Reinhold Martin, Bad Koenig (DE); Patrik Hartmann, Buettelborn (DE); Wolfgang Klesse, Mainz (DE); Joachim Knebel, Alsbach-Haehnlein (DE)

(73) Assignee: Evonik Roehm GmbH, Darmstadt (DE)

(21) Appl. No.: 13/203,993

(22) PCT Filed: Feb. 25, 2010
(86) PCT No.: PCT/EP2010/052384

§ 371 Date: Aug. 31, 2011

(30) Foreign Application Priority Data
Mar. 24, 2009 (DE) 10 2009 001 775.5

(51) Int. Cl. C09D 11/10; C08F 2/38; C08F 216/36

(52) U.S. Cl. 522/35; 526/316; 526/214

(57) ABSTRACT

The invention relates to a
(meth)acrylate polymer obtainable by polymerizing a mixture comprising
a) 0.1% to 99.9% by weight of at least one (meth)acrylate of the general formula I

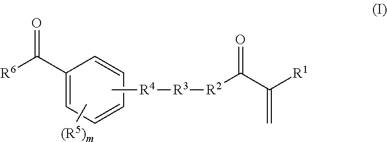

in which the radicals R1-R6 and also m take on the definition indicated in the description;
and
b) 99.9% to 0.1% by weight of one or a plurality of ethylenically unsaturated monomers which are different from a) and which are copolymerizable with a), the components a) and b) together making up 100% by weight of the polymerizable constituents of the mixture, the MW of the polymer being situated in the range from greater than or equal to 1000 g/mol to less than or equal to 50 000 g/mol.

The resulting polymers are preparable preferably by the route of suspension polymerization or bead polymerization and, preferably in solution in reactive diluent, serve as polymer-bonded photoinitiators or as an additive to UV-curable resins for a very wide variety of fields of application, particularly for printing inks.

### FIELD OF THE INVENTION

The invention describes (meth)acrylate polymers, preferably benzophenone-containing (meth)acrylate polymers, for use as polymer-bonded photoinitiators or in UV-curable resins.

### PRIOR ART

Benzophenone and low molecular weight benzophenone derivatives are widespread photoinitiators. On irradiation, free radicals are formed which are able to bring about the polymerization or crosslinking of ethylenically unsaturated monomers.

Carlini et al. in Polymer, 1983, Vol. 24, May, page 599 ff., report on polymers which comprise benzophenone chromophores in the side chain, and on their use as highly active photoinitiators. Copolymers of acryloyloxybenzophenone with methyl acrylate, menthyl acrylate or 1-acryloyloxy-2-ethoxyethane are disclosed. The copolymers described contain about 10 to 90 mol % of acryloyloxybenzophenone units and are suitable for the photoinitiation of polymerization. The cited publication does not exactly specify the molecular weight of the photoinitiators presented.

On the basis of the preparation process described in Carlini et al. (polymerization with AIBN at 60° C.), however, it is immediately clear to the skilled person that the molecular weights of the polymers must be very high and the resulting MW would be at least 60 000.

U.S. Pat. No. 5,900,472 A describes copolymerizable benzophenone derivatives for use as photoinitiators. The derivatives shown are benzophenone derivatives having two to four (meth)acrylate groups, and UV-curable coatings are presented that are obtainable by reacting the polyfunctional benzophenone derivatives with (meth)acrylate under radiation exposure. According to U.S. Pat. No. 5,900,472 A, the coatings obtainable using the polyfunctional benzophenone derivatives are superior to the then-existing coatings with known photoinitiators in that they exhibit a reduced tendency to “bleed”. Up until that point, unused photoinitiator had a tendency toward that phenomenon, thus confining its use to a few possibilities.

Where the known photoinitiators are used as an additive to printing inks for use in food pack surrounds, such as Tetrapak®s, for example, then, of course, a potentially migrating photoinitiator such as benzophenone is absolutely intolerable. In addition, there may also be odour problems affecting benzophenonenes or affecting the products of U.S. Pat. No. 5,900,472 A.

The polymer-bonded benzophenones of Carlini et al. may adversely affect the viscosity of the printing inks. An excessive viscosity may result in disruptive reactive kinetics and in incomplete curing or in retarded curing of the printing inks.

### OBJECT

In view of the prior art cited and discussed above, it was an object of the invention to specify (meth)acrylate polymers, preferably polymers comprising benzophenone or benzophenone derivatives, which are suitable for use as polymeric photoinitiators and/or as an additive to photopolymerizable resins.

The polymers are to be obtainable from simple building blocks by simple processes.

In addition, the polymers are to be highly reactive and to react as completely as possible when used as photoinitiators.

The new polymers are also to be controllable or adjustable in terms of their reactivity.

Moreover, the polymers, following their use, are to have very little tendency to bleed or to migrate. In other words, they are to be integrated as durably as possible into—for example—a resultant coating or covering.

The new photoinitiators ought in particular also to be suitable as additives to UV-curable printing inks, especially for the printing of food pack surrounds.

### SOLUTION

The objects of the invention, or aspects of the objects of the invention, are achieved by means of a

(meth)acrylate polymer obtainable by polymerizing a mixture comprising
a) 0.1 to 99.9% by weight of at least one (meth)acrylate of the general formula (I)

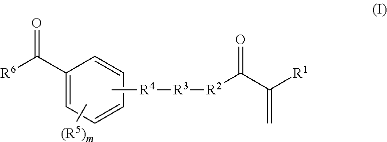

in which R¹ is hydrogen or methyl;
R² is oxygen or NH;
R³ is a radical of the general formula II

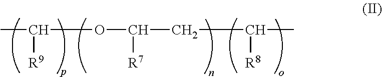

in which
R⁷, R⁸ and R⁹ independently of one another are hydrogen or methyl,
n is an integer from zero to two hundred,
o and p independently of one another are an integer from zero to two, and, if the sum of n and o and p is zero, R³ is a bond;
R⁴ is a bond, oxygen, NH, O—CO—O, HN—CO—O, HN—CO—NH or sulphur;
R⁵ is hydrogen, halogen or a radical which has one to 20 carbon atoms and is optionally substituted by oxygen, nitrogen and/or sulphur, m being an integer from one to five; and
R⁶ is an aryl or heterocyclyl radical;
and
b) 99.9% to 0.1% by weight of one or a plurality of ethylenically unsaturated monomers which are different from a) and are copolymerizable with a), the components a) and b) together making 100% by weight of the polymerizable constituents of the mixture, characterized in that the (meth)acrylate polymer has a weight-average molecular weight MW in the range from greater than or equal to 1000 g/mol to less than or equal to 50 000 g/mol, MW being measured by means of gel permeation chromatography against polymethyl methacrylate standards.

A polymer of this kind, used as a photoinitiator or as an additive in the curing of UV-curable resins, permits the creation of extremely advantageous coatings or coverings. More particularly, the polymer, as a constituent of a UV-curable printing ink, shows no tendency to migrate from the food pack surround into the packaged food. The polymer-bonded photoinitiators of the invention are very largely odour-neutral. Moreover, in the context of their use in printing inks, the viscosity of the printing inks is unaffected, or not substantially affected, by the amount normally added to the printing inks, and so the curing kinetics are not disrupted. This in turn allows the use of the printing ink comprising the photoinitiator of the invention on existing, standard printing lines.

### DETAILED DESCRIPTION OF THE INVENTION

The monomer composition comprises one or more (meth)acrylates a) of the general formula (I). The fraction of the (meth)acrylates a) as a proportion of the monomer mixture is in the range from 0.1 to 99.9 percent by weight, based on the total weight of the polymerizable constituents (sum of a) and b)).

The monomers of the formula (I) are present advantageously in an amount in the range from 0.5 to 50 percent by weight, more particularly in an amount in the range from 2.0 to 35.0 percent by weight and very preferably in the range from 5.0 to 30.0 percent by weight in the monomer mixture, based in each case on the total weight of the polymerizable constituents (sum of a) and b)).

It will be appreciated that in the context of the invention the notation “(meth)acrylates” refers both to methacrylates or acrylates and to a mixture of methacrylates and acrylates.

Monomer a) is at least one compound of the general formula

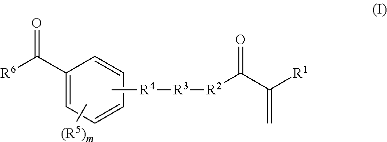

in which R¹ is hydrogen or methyl;
R² is oxygen or NH;
R³ is a radical of the general formula II

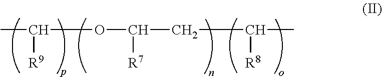

in which
R⁷, R⁸ and R⁹ independently of one another are hydrogen or methyl,
n is an integer from zero to two hundred,
o and p independently of one another are an integer from zero to two, and, if the sum of n and o and p is zero, R³ is a bond;
R⁴ is a bond, oxygen, NH, O—CO—O, HN—CO—O, HN—CO—NH or sulphur;
R⁵ is hydrogen, halogen or a radical which has one to 20 carbon atoms and is optionally substituted by oxygen, nitrogen and/or sulphur, m being an integer from one to five; and
R⁶ is an aryl or heterocyclyl radical which is advantageously arranged in conjugation with the adjacent carbonyl group.

In one advantageous modification of the process of the invention, the radical R¹ is a methyl group.

In another particularly preferred process variant, compounds of the formula (I) are used in which the radical R² is oxygen.

Also particularly advantageous are compounds of the formula (I) in which R¹ is a methyl group and R² is oxygen. In this combination, the radicals are methacryloyl radicals.

As is evident from this example, the combination and permutation of the preferred or advantageous process variants, particularly with regard to the use of the compound of the formula (I) with particularly preferred and/or advantageous radicals, is to be considered as belonging to the invention, and disclosed, in the course of the further description as well.

In another advantageous modification of the process of the invention, compounds of the formula (I) are used in which R³ and/or R⁴ are selected such that the attachment of the polymerizable ethylenically unsaturated function is accomplished via spacers in the form of ethylene or propylene oxide radicals. For this purpose it is preferred if the radical R³ is selected such that the sum of the indices n+o+p is greater that zero. With particular advantage, o and p are selected as zero, while n is an integer greater than zero, with particular advantage greater than five, and even more preferably greater than ten.

In one advantageous variant, the radicals R⁷ to R⁹ are selected such that they are all hydrogen.

Also of great interest, however, are those compounds of the formula (I) in which the radicals R⁷ to R⁹ are all methyl.

A particularly favourable process variant is obtained using compounds of the formula (I) in which R¹ is methyl, R² is oxygen, R⁴ is a bond, p and o are zero, R⁷ is hydrogen and the index n is an integer in the range from 1 to 50, more preferably 2 to 20 and even more preferably 5 to 10.

R⁵ is hydrogen, halogen or radicals which have one to 20 carbon atoms and which are optionally substituted by oxygen, nitrogen and/or sulphur, and where m is one to four.

Particularly advantageous variants of the invention use compounds of the formula (I) in which all four radicals R⁵ are hydrogen.

Radical R⁶ is an aryl radical or a heterocyclyl radical. With particular advantage R⁶ is an aryl radical. With particular preference R⁶ is a phenyl radical.

The linkage of the radical fragment —R⁴—R³—R²— to the aromatic moiety may take place in o, m or p position with respect to the carbonyl function on the aromatic moiety.

Preference is given to para linkage, i.e. 1-4-linkage.

In one particularly advantageous modification of the invention, monomer a) is made up of at least one benzophenone (meth)acrylate of the general formula (I′)

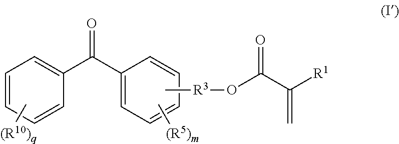

in which R¹, R³ and R⁵ and also m may take on the definition specified above for formula (I).

Independently of R⁵, R¹⁰ may take on the definitions of R⁵, namely hydrogen, halogen or a radical which has one to 20 carbon atoms and which is optionally substituted by oxygen, nitrogen and/or sulphur, with q being one to five.

An especially preferred embodiment of the invention is directed to those processes in which the compounds used as compounds a) are compounds which conform to the general formula (I″). In this case the monomer a) is made up of at least one benzophenone (meth)acrylate of the general formula I″

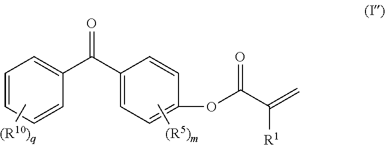

in which R¹, R⁵ and R¹⁰ and also m and q possess the definitions already given for the formulae (I) and (I′).

By halogen is meant the radicals fluorine, chlorine, bromine or iodine.

The radicals having 1 to 20 carbon atoms include, in a non-exhaustive listing, among others, (C1-C20)-alkyl, (C2-C20)-alkenyl, (C2-C20)-alkynyl, aryl or heterocyclyl, it being possible for the aryl or heterocyclyl radicals to be unsubstituted or to be provided with up to three, or else, in the case of fluorine, up to the maximum number, of identical or different radicals, and it being possible for one or more, preferably up to three, non-adjacent saturated carbon units in the stated alkyl, alkenyl or alkynyl radicals to be replaced by heteroatom units, such as oxygen or sulphur, and in which, furthermore, 3 to 6 atoms of these hydrocarbon radicals, optionally modified as above, may form a ring system, and these hydrocarbon radicals, with or without the stated variations, may optionally be substituted by one or more, preferably up to three, or, in the case of halogen, up to the maximum number, of identical or different radicals from the series halogen, preferably fluorine, aryl, aryloxy, arylthio, (C3-C8)-cycloalkoxy, (C3-C8)-cycloalkylthio, heterocyclyl, heterocyclyloxy or (C1-C2)-alkoxycarbonyl, it being possible for the cycloaliphatic, aromatic or heterocyclic ring systems among the substituents just stated to be unsubstituted or to be provided with up to three or else, in the case of fluorine, up to the maximum number of identical or different substituents.

The expression “(C1-C20)-alkyl” refers to an unbranched or branched hydrocarbon radical having 1 to 20 carbon atoms, such as the methyl, ethyl, propyl, isopropyl, 1-butyl, 2-butyl, 2-methylpropyl or tert-butyl radical, for example; and also, for example, the pentyl, 2-methylbutyl, 1,1-dimethylpropyl, hexyl, heptyl, octyl or the 1,1,3,3-tetramethylbutyl radical; and also, for example, the nonyl, 1-decyl, 2-decyl, undecyl, dodecyl, pentadecyl or eicosyl radical;

the expression “(C2-C20)-alkenyl” refers, for example, to the vinyl, allyl, 2-methyl-2-propenyl or 2-butenyl group; and also, for example, the 2-pentenyl, 2-decenyl or 2-eicosenyl group;
the expression “(C2-C20)-alkynyl” refers, for example, to the ethynyl, propargyl-, 2-methyl-2-propynyl or 2-butynyl group; and also, for example, the 2-pentynyl or the 2-decynyl group;
the expression “aryl” refers to an isocyclic aromatic radical having preferably 6 to 14, more particularly 6 to 12, C atoms, such as, for example, phenyl, naphthyl or biphenylyl, preferably phenyl.

The expression “aryloxy” refers for example to the phenoxy or 1- or 2-naphthyloxy group;

the expression “arylthio” refers for example to the phenylthio or 1- or 2-naphthylthio group;
the expression “(C3-C8)-cycloalkoxy” refers to a cyclopropyl, cyclobutyl, cyclopentyl, cyclohexyl, cycloheptyl or cyclooctyl group which is linked via an oxygen;
and the expression “(C3-C8)-cycloalkylthio” refers to a cyclopropyl, cyclobutyl, cyclopentyl, cyclohexyl, cycloheptyl or cyclooctyl group which is linked via a sulphur atom.

The expression “heterocyclyl” refers to a heteroaromatic or heteroaliphatic ring system, a “heteroaromatic ring system” being an aryl radical in which at least one CH group is replaced by N and/or at least two adjacent CH groups are replaced by S, NH or O, such as, for example, a radical of thiophene, furan, pyrrole, thiazole, oxazole, imidazole, isothiazole, isoxazole, pyrazole, 1,3,4-oxadiazole, 1,3,4-thiadiazole, 1,3,4-triazole, 1,2,4-oxadiazole, 1,2,4-thiadiazole, 1,2,4-triazole, 1,2,3-triazole, 1,2,3,4-tetrazole, benzo[b]thiophene, benzo[b]furan, indole, benzo[c]thiophene, benzo[c]furan, isoindole, benzoxazole, benzothiazole, benzimidazole, benzisoxazole, benzisothiazole, benzopyrazole, benzothiadiazole, benzotriazole, dibenzofuran, dibenzothiophene, carbazole, pyridine, pyrazine, pyrimidine, pyridazine, 1,3,5-triazine, 1,2,4-triazine, 1,2,4,5-triazine, quinoline, isoquinoline, quinoxaline, quinazoline, cinnolin, 1,8-naphthyridine, 1,5-naphthyridine, 1,6-naphthyridine, 1,7-naphthyridine, phthalazine, pyridopyrimidine, purine, pteridine or 4H-quinolizine;

the expression “heteroaliphatic ring system” refers to a cycloalkyl radical in which at least one carbon unit is replaced by O, S or a group NR″, and R″ is hydrogen, (C1-C4)-alkyl or aryl;
the expression “heterocyclyloxy” refers to one of the abovementioned heterocyclic radicals linked via an oxygen atom;
and (C1-C2)-alkoxycarbonyl is the methoxycarbonyl or ethoxycarbonyl group.

As already mentioned, in a preferred inventive embodiment, the compositions are distinguished by R¹ being methyl.

Of particular interest also are compositions in which R² is oxygen.

Of particular interest also are compositions in which R⁴ is a bond.

Of particular interest also are compositions in which p=o=0 and n is an integer between 1 and 20. For this case it is particularly advantageous if R⁷ is hydrogen.

Alternatively it is also preferred if p=o=n=0.

Of particular interest also are compositions in which all radicals R⁵ are hydrogen.

Of particular interest also are compositions in which R⁶ is phenyl.

Used with a special advantage as component a) for generating a polymer B) for the composition of the invention is methacryloyloxybenzophenone or benzophenone methacrylate.

The compounds of the formulae (I), (I′) and (I″) are either available commercially or are prepared by methods known from the literature. The possible preparation methods include, for example, the transesterification of (meth)acrylates with the corresponding alcohols or alcohol precursor compounds.

The monomer composition further comprises one or more ethylenically unsaturated comonomers b) which can be copolymerized with a) but are different from a). The fraction of the comonomers is situated preferably in the range from 99.9% to 0.01% by weight, more particular 50.0% to 99.5%, advantageously 65.0% to 98.0% by weight, and with particular preference 70.0% to 35.0% by weight, based on the weight of the polymerizable constituents (sum of the weights of a)+b)).

Comonomers b) that are suitable in this context conform, for example, to the formula (III):

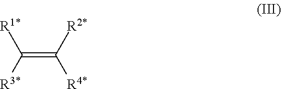

in which R¹* and R²* are each independently selected from the group consisting of hydrogen, halogens, CN, linear or branched alkyl groups having 1 to 20, preferably 1 to 6 and more preferably 1 to 4 carbon atoms, which may be substituted by 1 to (2n+1) halogen atoms, with n being the number of carbon atoms in the alkyl group (CF₃ for example), α,β-unsaturated linear or branched alkenyl or alkynyl groups having 2 to 10, preferably from 2 to 6 and more preferably from 2 to 4 carbon atoms, which may be substituted by 1 to (2n−1) halogen atoms, preferably chlorine, where n is the number of carbon atoms in the alkyl group, CH₂═CCl— for example, cycloalkyl groups having 3 to 8 carbon atoms, which may be substituted by 1 to (2n−1) halogen atoms, preferably chlorine, with n being the number of carbon atoms in the cycloalkyl group; aryl groups having 6 to 24 carbon atoms, which may be substituted by 1 to (2n−1) halogen atoms, preferably chlorine, and/or alkyl groups having 1 to 6 carbon atoms, where n is the number of carbon atoms in the aryl group; C(═Y*)R⁵*, C(═Y*)NR⁶*R⁷*, Y*C(═Y*)R⁵*, SOR⁵*, SO₂R⁵*, OSO₂R⁵*, NR⁸*SO₂R⁵*, PR⁵*₂, P(═Y*)R⁵*₂, Y*PR⁵*₂, Y*P(═Y*)R⁵*₂, NR⁸*₂, which may be quaternized with an additional R⁸*, aryl or heterocyclyl group, it being possible for Y* to be NR⁸*, S or O, preferably O; R⁵* is an alkyl group having 1 to 20 carbon atoms, an alkythio having 1 to 20 carbon atoms, OR¹⁵ (R¹⁵ is hydrogen or an alkali metal), alkoxy of 1 to 20 carbon atoms, aryloxy or heterocyclyloxy; R⁶* and R⁷* independently are hydrogen or an alkyl group having 1 to 20 carbon atoms, or R⁶* and R⁷* may together form an alkylene group having 2 to 7, preferably 2 to 5, carbon atoms, in which case they form a 3- to 8-membered ring, preferably 3- to 6-membered ring, and R⁸* is hydrogen, linear or branched alkyl or aryl groups having 1 to 20 carbon atoms;
in which R³* and R⁴* independently are selected from the group consisting of hydrogen, halogen (preferably fluorine or chlorine), alkyl groups having 1 to 6 carbon atoms and COOR⁹*, in which R⁹* is hydrogen, an alkali metal or an alkyl group having 1 to 40 carbon atoms, or R¹* and R³* may together form a group of the formula (CH₂)_{n′}, which may be substituted by 1 to 2n′ halogen atoms or C₁ to C₄ alkyl groups, or of the formula C(═O)—Y*—C(═O), where n′ is from 2 to 6, preferably 3 or 4, and Y* is as defined above; and where at least two of the radicals R¹*, R²*, R³* and R⁴* are hydrogen or halogen.

These comonomers include, among others:
Aryl (meth)acrylates, such as benzyl methacrylate or phenyl methacrylate, it being possible for the aryl radicals each to be unsubstituted or substituted up to four times;
methacrylates of halogenated alcohols, such as
2,3-dibromopropyl methacrylate,
4-bromophenyl methacrylate,
1,3-dichloro-2-propyl methacrylate,
2-bromoethyl methacrylate,
2-iodoethyl methacrylate,
chloromethyl methacrylate;
vinyl halides, such as vinyl chloride, vinyl fluoride, vinylidene chloride and vinylidene fluoride, for example;
vinyl esters, such as vinyl acetate;
styrene, substituted styrenes having an alkyl substituent in the side chain, such as α-methylstyrene and α-ethylstyrene, substituted styrenes having an alkyl substituent on the ring, such as vinyltoluene and p-methylstyrene, and halogenated styrenes, such as monochlorostyrenes, dichlorostyrenes, tribromostyrenes and tetrabromostyrenes, for example;
heterocyclic vinyl compounds, such as 2-vinylpyridine, 3-vinylpyridine, 2-methyl-5-vinylpyridine, 3-ethyl-4-vinylpyridine, 2,3-dimethyl-5-vinylpyridine, vinylpyrimidine, vinylpiperidine, 9-vinylcarbazole, 3-vinylcarbazole, 4-vinylcarbazole, 1-vinylimidazole, 2-methyl-1-vinylimidazole, N-vinylpyrrolidone, 2-vinylpyrrolidone, N-vinylpyrrolidine, 3-vinylpyrrolidine, N-vinylcaprolactam, N-vinylbutyrolactam, vinyloxolane, vinylfuran, vinylthiophene, vinylthiolane, vinylthiazoles and hydrogenated vinylthiazoles, vinyloxazoles and hydrogenated vinyloxazoles;
vinyl ethers and isoprenyl ethers;
   maleic acid and maleic acid derivatives, such as maleic anhydride, methyl maleic anhydride, maleinimide and methylmaleinimide, for example;
fumaric acid and fumaric acid derivatives;
acrylic acid and methacrylic acid;
dienes such as divinylbenzene, for example.

Hydroxyalkyl (meth)acrylates, such as
3-hydroxypropyl methacrylate,
3,4-dihydroxybutyl methacrylate,
2-hydroxyethyl methacrylate,
2-hydroxypropyl methacrylate,
2,5-dimethyl-1,6-hexanediol (meth)acrylate,
1,10-decanediol (meth)acrylate;
   carbonyl-containing methacrylates, such as
2-carboxyethyl methacrylate,
carboxymethyl methacrylate,
oxazolidynylethyl methacrylate,
N-(methacryloyloxy)formamide,
acetonyl methacrylate,
N-methacryloylmorpholine,
N-methacryloyl-2-pyrrolidinone,
N-(2-methacryloyloxyethyl)-2-pyrrolidinone,
N-(3-methacryloyloxypropyl)-2-pyrrolidinone,
N-(2-methacryloyloxypentadecyl)-2-pyrrolidinone,
N-(3-methacryloyloxyheptadecyl)-2-pyrrolidinone;
glycol dimethacrylates, such as
1,4-butanediol methacrylate,
2-butoxyethyl methacrylate,
2-ethoxyethoxymethyl methacrylate,
2-ethoxyethyl methacrylate;
methacrylates of ether alcohols, such as
tetrahydrofurfuryl methacrylate,
vinyloxyethoxyethyl methacrylate,
methoxyethoxyethyl methacrylate,
1-butoxypropyl methacrylate,
1-methyl-(2-vinyloxy)ethyl methacrylate,
cyclohexyloxymethyl methacrylate,
methoxymethoxyethyl methacrylate,
benzyloxymethyl methacrylate,
furfuryl methacrylate,
2-butoxyethyl methacrylate,
2-ethoxyethoxymethyl methacrylate,
2-ethoxyethyl methacrylate,
allyloxymethyl methacrylate,
1-ethoxybutyl methacrylate,
methoxymethyl methacrylate,
1-ethoxyethyl methacrylate,
ethoxymethyl methacrylate and ethoxylated (meth)acrylates which have preferably 1 to 20, more particularly 2 to 8, ethoxy groups;
aminoalkyl (meth)acrylates and aminoalkyl (meth)acrylamides, such as
N-(3-dimethylaminopropyl)methacrylamide,
dimethylaminopropyl methacrylate,
3-diethylaminopentyl methacrylate,
3-dibutylaminohexadecyl (meth)acrylate;
nitriles of (meth)acrylic acid, and other nitrogen-containing methacrylates, such as
N-(methacryloyloxyethyl)diisobutylketimine,
N-(methacryloyloxyethyl)dihexadecylketimine,
methacryloylamidoacetonitrile,
2-methacryloyloxyethylmethylcyanamide,
cyanomethyl methacrylate;
   heterocyclic (meth)acrylates, such as
2-(1-imidazolyl)ethyl (meth)acrylate,
2-(4-morpholinyl)ethyl (meth)acrylate and
1-(2-methacryloyloxyethyl)-2-pyrrolidone;
oxiranyl methacrylates, such as
2,3-epoxybutyl methacrylate,
3,4-epoxybutyl methacrylate,
10,11-epoxyundecyl methacrylate,
2,3-epoxycyclohexyl methacrylate,
10,11-epoxyhexadecyl methacrylate; and also
glycidyl methacrylate.

Particularly suitable comonomers b) include, among others, methacrylates, acrylates, styrenes and mixtures which comprise two or more components of the aforementioned groups. Examples of (meth)acrylates are methyl (meth)acrylate, ethyl (meth)acrylate, propyl (meth)acrylate, isopropyl (meth)acrylate, butyl (meth)acrylate, isobutyl (meth)acrylate, hexyl (meth)acrylate, ethylhexyl (meth)acrylate, cyclohexyl (meth)acrylate, tetrahydrofurfuryl (meth)acrylate, isobornyl (meth)acrylate, benzyl (meth)acrylate, phenyl (meth)acrylate, phenylethyl (meth)acrylate, 3,3,5-trimethylcyclohexyl (meth)acrylate, hydroxyethyl (meth)acrylate, hydroxypropyl (meth)acrylate, methyl- or ethyltriglycol methacrylate, butyldiglycol methacrylate, ethylene glycol di(meth)acrylate and also diethylene glycol di(meth)acrylate, triethylene glycol di(meth)acrylate and the higher homologues thereof, dipropylene glycol di(meth)acrylate, tripropylene glycol di(meth)acrylate and the higher homologues thereof, 1,3- and 1,4-butanediol di(meth)acrylate, 1,6-hexanediol di(meth)acrylate, 1,12-dodecanediol di(meth)acrylate, glycerol di(meth)acrylate, trimethylolpropane tri(meth)acrylate, trimethylolpropane di(meth)acrylate, tri(meth)acrylate of an ethoxylated trimethylolpropane with 3-10 mol of ethylene oxide, di(meth)acrylate of an ethoxylated bisphenol-A with 2-20 mol of ethylene oxide, preferably 2-10 mol of ethylene oxide and/or a polyethylene glycol dimethacrylate having 1-15 ethylene oxide units and allyl (meth)acrylate. Further examples are (meth)acrylic acid, (meth)acrylamide, N-methylol (meth)acrylamide, monoesters of maleic and succinic acid with hydroxyethyl methacrylate, and the phosphoric ester of hydroxyethyl (meth)acrylate, whose fraction is usually minor.

It will be appreciated, furthermore, that in order to generate a polymer of the invention it is also possible to employ two or more varieties of monomers b). Thus the polymer of the invention may also be obtained by polymerizing two or more different monomers of variety b).

Of particular interest for the invention are polymers which are characterized in that component b) is selected from (meth)acrylate monomers. In this case it is especially preferred for component b) to be methyl methacrylate.

In another embodiment it is preferred for component b) to be n-butyl methacrylate.

Particular polymers of the invention are also obtainable using a component b) which is selected from (meth)acrylates having 3 to 5 carbon atoms in the ester group. These include, among others, propyl methacrylate, n-butyl methacrylate, tert-butyl methacrylate and n-pentyl methacrylate. Of the monomers stated, n-butyl methacrylate is particularly preferred.

Particular polymers of the invention are likewise distinguished by the fact that b) is a mixture of monomers comprising methyl methacrylate and n-butyl methacrylate.

Especially preferred polymers of the invention are obtainable by copolymerizing benzophenone methacrylate, methyl methacrylate and n-butyl methacrylate.

The polymers of the invention are obtained by radical polymerization. The customary free radical polymerization is described exhaustively in references including Ullmann's Encyclopedia of Industrial Chemistry, Sixth Edition.

In the context of the present invention the polymerization is started by using at least one polymerization initiator for radical polymerization. These include, among others, the initiators that are widely known in the art and are azo initiators, such as 2,2′-azobisisobutyronitrile, 2,2′-azobis-(2,4-dimethylvaleronitrile) and 1,1-azobiscyclohexanecarbonitrile, organic peroxides, such as dicumyl peroxide, diacyl peroxides, such as dilauroyl peroxide, peroxydicarbonates, such as diisopropyl peroxydicarbonate, peresters, such as tert-butyl peroxy-2-ethylhexanoate, and the like.

Especially suitable polymerization initiators comprise, for the purposes of the present invention, the following compounds more particularly:
methyl ethyl ketone peroxide,
acetylacetone peroxide,
dilauroyl peroxide,
tert-butyl per-2-ethylhexanoate,
ketone peroxide,
tert-butyl peroctoate,
methyl isobutyl ketone peroxide,
cyclohexanone peroxide,
dibenzoyl peroxide,
tert-butyl peroxybenzoate,
tert-butyl peroxyisopropyl carbonate,
2,5-bis-(2-ethylhexanoylperoxy)-2,5-dimethylhexane,
tert-butyl peroxy-2-ethyl hexanoate,
tert-butyl peroxy-3,5,5-trimethylhexanoate,
dicumyl peroxide,
1,1-bis(tert-butylperoxy)cyclohexane,
1,1-bis(tert-butylperoxy)-3,3,5-trimethylcyclohexane,
cumyl hydroperoxide,
tert-butyl hydroperoxide,
bis(4-tert-butylcyclohexyl) peroxydicarbonate,
2,2′-azobisisobutyronitrile,
2,2′-azobis(2,4-dimethylvaleronitrile),
1,1-azobiscyclohexanecarbonitrile,
diisopropyl peroxydicarbonate,
tert-amyl peroxypivalate,
di-(2,4-dichlorobenzoyl) peroxide,
tert-butyl peroxypivalate,
2,2′-azobis(2-amidinopropane) dihydrochloride,
di(3,5,5-trimethylhexanoyl) peroxide,
dioctanoyl peroxide,
didecanoyl peroxide,
2,2′-azobis-(N,N′-dimethyleneisobutyramidine),
di-(2-methylbenzoyl) peroxide,
dimethyl-2,2′-azobisisobutyrate,
2,2′azobis(2-methylbutyronitrile),
2,5-dimethyl-2,5-di(2-ethylhexanoylperoxy)hexane,
4,4′-azobis(cyanopentanoic acid)
di-(4-methylbenzoyl) peroxide,
dibenzoyl peroxide,
tert-amyl peroxy-2-ethylhexanoate,
tert-butyl peroxy-2-ethylhexanoate,
tert-butyl peroxyisobutyrate
   and also mixtures of the aforementioned polymerization initiators.

The polymers of the invention may be obtained in bulk or else in solution. Preference, however, is given to their being obtained by polymerization by the suspension polymerization process, the so-called bead polymerization. In the case of direct suspension polymerization processes, water-insoluble monomers are suspended in water by mechanical stirring. The polymerization is started in the monomer droplets by addition of an “oil-soluble” initiator. The coagulation of the droplets (and hence the coagulation of the suspension) is prevented by “protective colloids” (i.e. suspending agents) such as, for example, Ba2SO4, poly(vinyl alcohol) or others. After the end of the polymerization, the polymer is in the form of small beads (50-400 μm) in dispersion in water. In the case of this “water-cooled bulk polymerization” there are no heat problems and there is no need to remove any organic solvents from the polymer product. The “bead polymer” obtained in this way can frequently be processed further without being pelletized.

The polymerization for preparing the polymers of the invention may be carried out in either the presence or the absence of a chain-transfer agent. The polymerization is preferably carried out in the presence of a chain-transfer agent or so-called regulator. As chain-transfer agents it is possible to use typical species described for radical polymerizations, of the kind known to a person skilled in the art.

Especially advisable is the use of mercaptans, such as, for example, n-butyl mercaptan, n-dodecyl mercaptan, 2-mercaptoethanol, 2-ethylhexyl thioglycolate or pentaerythritol tetrathioglycolate, the chain-transfer agent being used preferably in amounts of 0.05% to 5.0%, more preferably in amounts of 0.1% to 2.0% and very preferably in amounts of 0.2 to 1.0% by weight, based in each case on the total mass of the ethylenically unsaturated compounds. In this context, a person skilled in the art may consult the technical literature, especially the publications of H. Rausch-Puntigam, T. Völker “Acryl-und Methacrylverbindungen”, Springer, Heidelberg, 1967; Houben-Weyl “Methoden der organischen Cheme” vol. XIV/1, p. 66ff., Georg Thieme, Heidelberg, 1961 and Kirk-Othmer “Encyclopedia of Chemical Technology” Vol. 1, p. 296ff., J. Wiley, New York, 1978. In the context of the present invention the use of 2-ethylhexyl thioglycolate or pentaerythritol tetrathioglycolate as chain-transfer agent or regulator is especially preferred. In one preferred embodiment these agents are used in an amount of 0.05% to 5% by weight, based on the total mass of components a) and b).

The molecular weight of the benzophenone (meth)acrylate-containing comonomer of the invention is critical. The weight-average molecular weight MW is in the range from greater than or equal to 1000 g/mol to less than or equal to 50 000 g/mol. If the MW is below 1000 g/mol, there may be instances of odour nuisance owing to the photoinitiator. Moreover, under certain circumstances, the security against migration is inadequate. If the MW is above 50 000 g/mol, then the viscosity of a printing ink becomes too high, with the consequence either that the reaction kinetics of the curing operation are disrupted or else the addition of, for example, reactive diluents (monomers) to the printing ink formulation becomes necessary, with the known consequent problems. In the context of the present invention, the amounts of monomers, polymerization initiator, chain-transfer agent and, where appropriate, solvent are selected preferably so as to give a weight-average molecular weight in the range from 1000 to 20 000 g/mol, preferably in the range from 1000 to 10 000 g/mol, more preferably in the range from 1500 to less than 10 000 g/mol, advantageously in the range from 2000 to 3500 g/mol, more particularly in the range from 2500 to 3500 g/mol. Particular preference is also given to molecular weights of less than 5000 g/mol. These figures relate in each case to the weight-average molecular weight (Mw).

The molecular weights can be determined by known methods. As an example it is possible to use gel permeation chromatography, also known as “Size Exclusion Chromatography” (SEC). Likewise employable is an osmometric method, such as “Vapour Phase Osmometry”, for example, for determining the molecular weights. The stated methods are for example described in: P. J. Flory, “Principles of Polymer Chemistry” Cornell University Press (1953), Chapter VII, 266-316, and also in “Macromolecules, an Introduction to Polymer Science”, F. A. Bovey and F. H. Winslow, Editors, Academic Press (1979), 296-312 and also in W. W. Yau, J. J. Kirkland and D. D. Bly, “Modern Size Exclusion Liquid Chromatography”, John Wiley and Sons, New York, 1979. For determining the molecular weights of the polymers presented herein, preference is given to using gel permeation chromatography. Measurement is made against polymethyl methacrylate standards.

The glass transition temperature of the polymer-bonded benzophenones of the invention may vary over a certain range. The glass transition temperatures are situated advantageously at Tg>40° C. as determined by means of DSC in accordance with DIN EN ISO 6721-2. If Tg is below 40° C., a relatively large amount of a polymer-bonded initiator, when employed in a printing ink or in a coating, may adversely affect its hardness. Preference in the context of the invention is given to glass transition temperatures Tg of >50° C., even more preferably of >60° C.

The polymerization to obtain the polymers of the invention can be carried out under atmospheric pressure, subatmospheric or superatmospheric pressure. The polymerization temperature as well is not critical. Generally speaking, however, it is in the range of −20°-200° C., preferably in the range of 0°-180° C., advantageously in the range of 50°-180° C., more preferably in the range of 50°-130° C., and more particularly in the range of 60°-120° C.

The polymerization is carried out preferably at a constant reaction temperature, which during the entire polymerization reaction fluctuates preferably by less than +−20° C., more preferably by less than +−10° C., more particularly by less than +−5° C., around the desired temperature.

For this purpose the polymerization vessel is preferably surrounded by a medium which is able to remove the developing heat of polymerization as rapidly and effectively as possible. For further reduction in temperature fluctuations it has proved to be very favourable to control the temperature in the polymerization vessel through the rate of addition of the polymerization initiator, by briefly increasing the rate of addition of the polymerization initiator in order to raise the temperature, and briefly lowering the rate of addition of the polymerization initiator in order to reduce the temperature.

Moreover, a favourable procedure is to charge the reaction mixture comprising the ethylenically unsaturated compounds to a reaction vessel, to heat the reaction mixture at the desired polymerization temperature, using a suitable heating medium, until the reaction mixture has the desired polymerization temperature, to initiate the polymerization by addition or metering of the polymerization initiator, and, directly after the addition or directly after the beginning of metering of the polymerization initiator, to lower the temperature of the heating medium relative to the temperature set beforehand, preferably by 2 to 10° C., more particularly by 5 to 10° C.

The copolymer of the invention can be used with particular advantage as a UV initiator for polymerization reactions. In this context it may be of particularly advantage if the polymer is present in the form of a solution in a reactive diluent. Reactive diluents in this context are understood to be those media which on the one hand are able to dissolve the polymer-bound UV initiator and on the other hand participate in a polymerization reaction triggered by the polymeric UV initiator, and are incorporated by copolymerization into the polymers being prepared. Especially advantageous reactive diluents for the application of the polymer in accordance with the invention include, for example, polyfunctional (meth)acrylates. The polyfunctional (meth)acrylates in question include, among others, diacrylates or triacrylates. A very particularly preferred example is tripropylene glycol diacrylate. The concentration of the ready-to-use solution can be readily tailored to the desired end use, as a function of the desired reactivity of the UV initiator. Concentrations in the range from 10 to 70 percent (w/w) have emerged as being favourable. Particular preference is given to 20 to 50 percent strength solutions (w/w) in, preferably, tripropylene glycol diacrylate.

The rate of initiation/crosslinking can with particular advantage be further improved or tailored to the desired target rates by combined application with an amine accelerant.

In one preferred embodiment of the invention the benzophenone-containing polymer of the invention is employed in combination with an amine, the amine being selected from the group of low molecular mass amines, polymeric amines and polymerizable amines.

Particularly advantageous is its conjoint use with NDEA (N-methyldiethanolamine) or else with DMAEMA (2-diethylaminoethyl methacrylate).

The polymer-bound initiator of the invention can preferably also be successfully employed as an additive to UV-curable resins, more particularly as an additive to printing inks.

A printing ink composition which is favourable in the context of the invention comprises:

A.) colorant(s) B.) UV-curable binders, C.) typical auxiliaries such as rheology modifiers, drying modifiers, gloss modifiers and surface hardness modifiers, and D.), based on the sum of the weight of A.) to D.) 0.1% to 30% by weight of a polymer-bound initiator of the invention.

One particularly advantageous printing ink variant comprises in accordance with the invention
A) 10%-40% by weight colorant(s);
B) 10%-50% by weight binder(s);
C1) 20%-80% by weight solvent(s) or diluent(s);
C2) 0%-10% by weight customary, non-C1) auxiliaries; and
D) 0.5%-25% by weight a polymer-bound UV initiator/crosslinker in accordance with the invention.

Particularly preferred is a composition comprising components A) to D) in the following amounts:
A) about 20% by weight;
B) 29-40% by weight;
C1) about 15% by weight;
C2) 9-26% by weight; and
D) 10-16% by weight.

One specific composition comprises:

| | | |
|---|---|---|
| 33-39% | by weight | reactive diluent; |
| 15% | by weight | thixotropic paste; |
| 20% | by weight | matting paste; |
| 3% | by weight | photoinitiator for white; |
| 5% | by weight | UV luminescence paste; |
| 3% | by weight | anti-toning agent; |
| 5% | by weight | UV additives; and |
| 10-16% | by weight | polymer-bound UV initiator in |
| | | accordance with the invention. |

In this case the polymer-bound photoinitiator is with particular advantage such that it represents a benzophenone content of approximately 5% by weight, based on the overall printing ink formula.

The colorants A) which can be employed with great success include, among others, inorganic pigments such as mineral pigments, e.g. Milori blue, titanium white, iron oxide pigments; such as metal pigments, e.g. aluminium powders (silver bronze PM1), brass powders (gold bronze PM2), Cu—Zn alloys, copper bronze; such as interference pigments, e.g. mother-of-pearl pigments, pearlescent pigments and oxidized bronzes; such as carbon pigments, e.g. pigmentary carbon blacks, colour blacks, in each case coarse- and/or fine-grained; organic pigments such as azo pigments, couplings of monoazo and disazo compounds and lacked, isoindoline pigments, phthalocyanine pigments, speciality pigments based on polycyclic compounds, such as those based on dioxazine, quinacridone, indanthrene and isoindolinone derivatives, for example; salts of basic dyes, e.g. Fanal® products from BASF, alkali blue, Reflexblau® (Höchst type); luminescent pigments; fluorescent pigments; phosphorescent pigments; and also soluble organic dyes, primarily for flexographic printing, colour bases such as, for example, Victoria blue B base, Nigrosin B base; and metal complex dyes, such as Zapon® or Neozapon® dyes, for example.

The binders B) that can be used advantageously include, in a non-exhaustive listing, the following among others:

Fats, oxidatively drying or else non-drying oils and alkyd resins prepared therefrom, such as fatty drying oils of plant origin, for example, e.g. linseed oil, tung oil, soybean oil, ricinene oil, tall oil and their derivatives (partly polymerized, hydrogenated or dehydrated oils, oil-resin amalgations, fatty acid-modified alkyd resins (phthalic acid+glycerol+drying oils), free fatty acids, fatty alcohols, etc.),

gold leaf varnish (by prolonged heating of linseed oil);
solutions or dispersions of modified natural resins and synthetic resins in mineral oils or vegetable oils, e.g. balsam resins and root resins and their derivatives (resin esters, hard resins, alkaline earth metal resinates, zinc resinates), phenol- and maleinate-modified natural resins, synthetic resins, such as coumaron, indene and cyclopentadiene resins, HC (hydrocarbon) resins, high-viscosity mineral oil products and terpene resins; natural fossil materials, such as natural asphalt and dissociation residues from natural resin, tall oil, mineral oils, tar oils and the fatty acid processing products thereof;
and also Gilsonit asphalt;
Rosin derivatives in the form of phenolic resins, Ca/Mg and Zn salts, hydrocarbon resins, cellulose derivatives;
mobile solutions of synthetic resins, modified natural resins and natural resins, such as, for example, nitrocellulose and combinations of corresponding resins and plasticizers;
combination resins: ethylcellulose, ethylhydroxyethylcellulose, cellulose esters, carboxymethylcellulose, rosin esters, maleic acid-modified rosins (maleinate resins);
chain-growth addition polymers and copolymers of vinyl acetate, vinyl chloride, vinylidene chloride, styrene, methylstyrene, cyclopentadiene, acrylates, methacrylates, maleic esters, vinyl acetals, vinyl alcohol, vinylpyrrolidones, butadiene; polyaddition resins such as polyurethanes, epoxides; polycondensation resins, such as polyesters, polyamides, aliphatic and aromatic ketone resins, melamine-urea resins, melamine-formaldehyde resins, casein.

Solvents and/or diluents which can be successfully employed include, among others, hydrocarbons, mineral oils, alcohols, glycols, glycol ethers, esters, ketones, water; especially ethanol, denatured with methyl ethyl ketone or cyclohexane, ethyl acetate, 2-propanol, 1-methacryloyl-2-propanol, 1-ethoxy-2-propanol, water acetone, benzines, including cycloaliphatics, dipropylene glycol monomethyl ether, ethoxypropyl acetate, isopropyl acetate, methoxypropyl acetate, methyl ethyl ketone, methoxypropyl ketone, 1-propanol, propyl acetate, propylene glycol, diacetone alcohol, cyclohexanone, methyl isobutyl ketone, toluene and/or xylene.

Advantageous auxiliaries include, among others, fillers such as calcium carbonate (chalk PW18), aluminium oxide hydrate (PW24), barium sulphate (PW21-heavy spar), silicon dioxide (silica SiO₂ PW27), aluminium silicate (kaolin PW19) or magnesium silicate (talc PW26), or mixtures of two or more of the aforementioned fillers;

waxes, e.g. natural waxes such as carnauba wax or ozokerite wax; synthetic waxes, such as PE waxes, oxidized carboxyl-containing PE waxes, fluorinated waxes, PTFE waxes, petroleum waxes, paraffin gels, ceresin wax;
fatty acid amides, e.g. oleamide or stearamide;
plasticizers, such as products of natural origin (e.g. castor oil; epoxidized soybean oil) or synthetic origin such as phthalic esters (dibutyl phthalate (DBP), diisobutyl phthalate (DiBP), dioctyl phthalate (DOP), diisooctyl phthalate (DiDP), dicyclohexyl phthalate, diisononyl phthalate), abietates, benzoates, adipates, sebacates, phosphates and/or alkyd resins;
Dryers such as, for example, liquid dryers, such as oil-soluble metal soaps (octanoates, resinates, naphthenates, tallates, linoleates), such as, for example, drying pastes (dispersions of inorganic salts in oils; Mg salts ground in linseed oil varnishes);
drying retardant antioxidants, such as oxines, substituted phenols, aromatic amines and naphthols;
wetting agents such as, for example, anionic wetting agents, e.g. salts of acids, especially fatty acids; cationic wetting agents, e.g. quaternary ammonium compounds;
non-ionic wetting agents, such as ethoxylated alkylphenols; and amphoteric wetting agents such as, for example, alkyldimethylbetaine;
neutralizing agents such as, for example, acrylates, ammonia or amino alcohols; fungicides and bactericides;
crosslinkers, examples being polyisocyanates or polyacridines, photoinitiators other than D);
antifoam agents, complexing agents, and other additives.

The examples which follow serve for further illustration of the invention.

Preparation of (Meth)Acrylate Polymers, Preferably Benzophenone-Containing inventive and comparative Examples 1 to 11.

### General Polymerization Procedure

In an apparatus consisting of a 2 l Rettberg reactor with stirrer motor and metal-blade stirrer, reflux condenser, N₂-blanketing, water bath thermostat and thermocouple, the amounts below are employed for approximately 500 g of bead polymers in each case.

The specific numerical values relate to inventive Example 9.

The amounts for experiments 1 to 8 and 10 and 11 should be modified in accordance with the portions indicated in Table 1.

Phase ratio H₂O:monomer = 2.0:1

| | | |
|---|---|---|
| Monomer phase: | | |
| MMA | 300.0 g = | 60% of monomers |
| n-BMA | 75.0 g = | 20% of monomers |
| BPMA¹ | 100.0 g = | 10% of monomers |
| Chain-transfer agent² | 25.0 g = | 10% of monomers |
| Initiator³ | 0.5 g = | 0.10% of monomers |
| Water phase: | | |
| H₂O distilled | 941.5 g | |
| Al₂(SO₄)₃*14 H₂O | 10.0 g = | 2.0% of monomers |
| Sodium carbonate solution, | 44.0 g = | 4.4 times amount of |
| 10% strength | | aluminium sulphate |
| Auxiliary dispersant 1⁴ | 10.0 g = | 100% of aluminium sulphate |
| 1% strength | | |
| Auxiliary dispersant 2⁵ | 10.0 g = | 100% of aluminium sulphate |
| 1% strength | | |

¹4-Hydroxybenzophenone methacrylate
²Pentaerythritol tetrathioglycolate
³Azobis(isobutyronitrile)
⁴C15-Paraffinsulphonate, Na salt, e.g. Emulgator K 30 (Bayer)
⁵Polyethylene glycol, molar weight => 5000, e.g. Polywachs 5000/6000 (Hoechst)

The polymerization is conducted as follows.

The entire amount of water and the aluminium sulphate are heated to 80° C. with stirring and under nitrogen blanketing. When the predetermined temperature is reached, sodium carbonate solution is added all at once to precipitate the aluminium hydroxide. This is followed by the addition of the auxiliary dispersants as a 1% strength solution. Thereafter the pH of the water phase is checked. It is 5.5. Subsequently the monomer solution is added all at once (in batch form). After the temperature maximum, stirring is continued at 90° C. for a further hour. The mixture is then cooled to 40° C. and acidified with 20 ml of 50% strength sulphuric acid. The batch is cooled further, discharged onto a porcelain suction filter with a circular paper filter (type MN 616, retention range 4-12 μm) and washed to neutrality with 5 l of DI water. The bead polymer is dried at 50° C. for around 20 h (rack drying).

The batch proportions for experiments 1 to 11 and also the results obtained in the polymerization are listed in Tables 1 and 2 below.

TABLE 1

| | | | | | Characterization | | |
|---|---|---|---|---|---|---|---|
| | | | 4-Hydroxy- | | | PSD V50 [μm] | |
| | | | benzophenone | Pentaerythritol | Tg | with | without |
| | MMA | n-BMA | methacrylate | tetrathioglycolate | [° C.] | US | US |
| Exp. 1 | 65 | 20 | 10 | 5 | 70 | 106 | 111 |
| Exp. 2 | 55 | 20 | 20 | 5 | 73 | 110 | 116 |
| Exp. 3 | 35 | 20 | 40 | 5 | 70 | 151 | 153 |
| Exp. 4 | 52 | 20 | 20 | 8 | 55 | 110 | 125 |
| Exp. 5 | 52 | 20 | 20 | 10 | 45 | 108 | 117 |
| Exp. 6 | 58 | 20 | 20 | 2 | 84 | 82 | / |
| Exp. 7 | 60 | 20 | 20 | 0 | 94 | 120 | / |
| Exp. 8 | 62 | 20 | 10 | 8 | 55 | 59.6 | / |
| Exp. 9 | 60 | 20 | 10 | 10 | 44 | 75.2 | / |
| | | | 4-Hydroxy- | | | | |
| | | | benzophenone | 2-Ethylhexyl | | | |
| | MMA | n-BMA | methacrylate | thioglycolate | | | |
| Exp. 10 | 52 | 20 | 20 | 8 | 44 | 74 | / |
| | | | | Pentaerythritol | | | |
| | MMA | n-BMA | DMAEMA | tetrathioglycolate | | | |
| Exp. 11 | 65 | 20 | 10 | 5 | 66 | 253 | / |

MMA: Methyl methacrylate
n-BMA: n-Butyl methacrylate
DMAEMA: 2-Dimethylaminoethyl methacrylate
PSD: Particle Size Distribution
US: Ultrasound

The PSD determination was carried out by means of a Malvern Mastersizer 2000 (with or without application of ultrasound).

The glass transition temperature was determined in accordance with EN ISO 11357. In particular, the glass transition temperature, Tg (also known as glass temperature) was determined by the method specified in ISO 11357-2.

The weight-average molecular weights Mw of the (meth)acrylate polymers of the invention were determined by means of SEC (Size Exclusion Chromatography) for hydrophobic polymers. This was done using the measurement system below, which is characterized as follows:

| Columns: | 5 SDV columns 8 × 300 mm or 8 × 50 mm from | | | | |
|---|---|---|---|---|---|
| | PSS at Mainz 1 Solvent Peak Separation | | | | |
| | column 8 × 100 mm from Shodex | | | | |
| | No. | Type | | Dimension | |
| | Preliminary | SDV 100 Å | 10 μ | 8 × 50 | mm |
| | column | | | | |
| | 1 | SDV LinL | 10 μ | 8 × 300 | mm |
| | 2 | SDV LinL | 10 μ | 8 × 300 | mm |
| | 3 | SDV 100 Å | 10 μ | | |
| | 4 | SDV 100 Å | 10 μ | 8 × 300 | mm |
| | 5 | KF-800D | | 8 × 100 | mm |

| | | | |
|---|---|---|---|
| Apparatus: | Agilent 1100 Series | Pump | G1310A |
| | Agilent 1100 Series | Autosampler | G1313A |
| | Agilent 1100 Series | UV detector | G1314A |
| | Agilent 1100 Series | RI detector | G1362A |
| | Agilent 1100 Series | Control module | G1323B |
| | Techlab | Column oven | K-5 |

| | |
|---|---|
| Column oven: | Temperature level 35° C. |
| Eluent: | Tetrahydrofuran |
| | is permanently distilled, gased |
| | with helium and pumped in circulation |
| Flow rate: | 1 ml/min |
| Injection volume: | 100 μl |
| Detection: | RI: Temperature level 35° C. |
| | Attenuation 250 000 nRIU/1V |
| UV: | Wavelength 239 nm |
| | Attenuation 500 mAU/1V |
| Offset: | 0.175 ml (time offset between |
| | UV and RI signals) |
| EDP: | PSS WinGPC software |
| Concentration of | 2 g/l (for Mw > 10⁶:1 g/l . . . 0.25 g/l) |
| sample solution: | |
| Standards: | PMMA (e.g. from PSS (Mainz) and |
| | Polymer Laboratories) |
| Concentration of | 1 g/l (for Mw > 10⁶:0.5 g/l, MW > |
| standard solutions: | 2*10⁶:0.25 g/l) |
| (narrow | |
| distribution) | |
| Internal | o-dichlorobenzene → |
| Standard: | 1 drop per 1.5 ml autosampler vial |
| Calibration curve: | with internal standard = 49.40 ml |

TABLE 2
Characterization

| | Mn | Mw | D | PETG |
|---|---|---|---|---|
| Exp. 2 | 7470 | 12 100 | 1.62 | 5 |
| Exp. 4 | 4890 | 7330 | 1.5 | 8 |
| Exp. 5 | 3950 | 5670 | 1.43 | 10 |
| Exp. 6 | 18 300 | 32 100 | 1.75 | 2 |
| Exp. 7 | 394 000 | 2 060 000 | 5.22 | 0 |
| | | | | EHTG |
| Exp. 10 | 3130 | 6010 | 1.92 | 8 |

PETG = Pentaerythritol tetrathioglycolate
EHTG = 2-Ethylhexyl thioglycolate

### Polymerization Time Measurement:

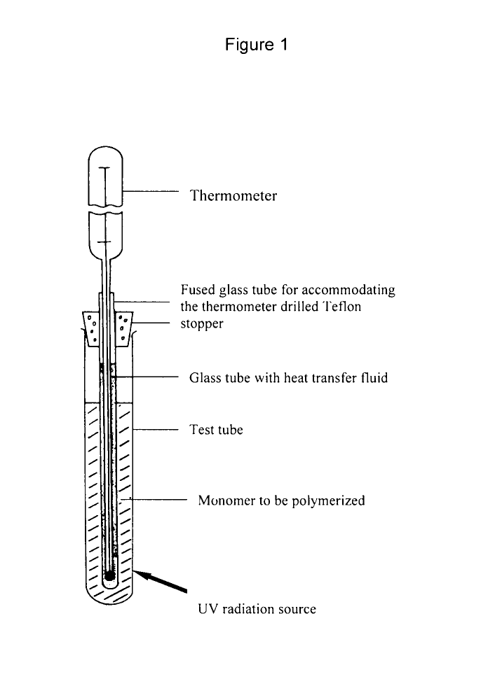

The polymer solutions were weighed out to 20 g in test tubes. In the middle of the test tubes a tube with a lid was fixed. In this tube, diethylene glycol, as carrier liquid, was introduced to approximately 6 cm. The thermocouples were placed in the central tube and the samples were placed at a distance of 2.5 cm from the lamps. This produces a radiant output of 1 mW/cm². The principle of an experimental set-up is shown in the appended FIG. 1.

The UV polymerization time measurements were carried out employing all of the polymers from Table 2, i.e. those with a BPMA content (4-hydroxybenzophenone methacrylate) of 20% (Exp. 2, Exp. 4-7 and Exp. 10).

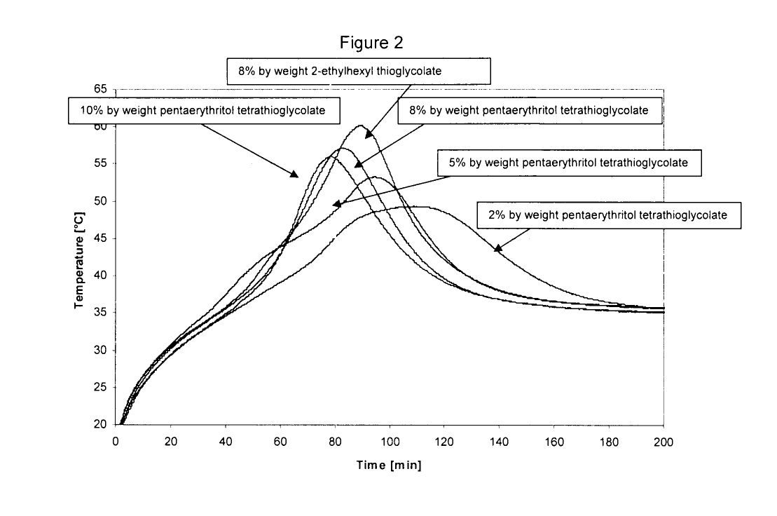

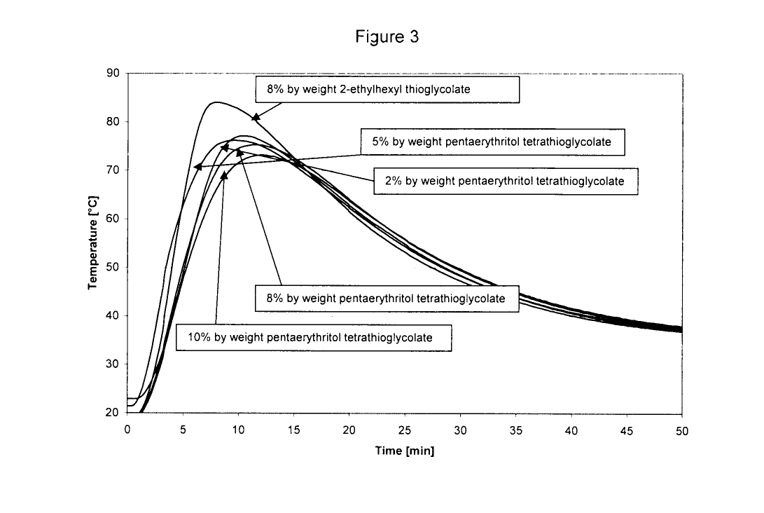

The results obtained in the polymerization time measurements are shown in the appended FIGS. 2 and 3. In those figures:

FIG. 2 shows the temperature/time profile for the polymerization of tripropylene glycol diacrylate, using 37.5% by weight of the polymeric photoinitiators characterized in Table 2;

FIG. 3 shows the temperature/time profile for the polymerization of tripropylene glycol diacrylate using 37.5% by weight of the polymeric photoinitiators characterized in Table 2, with addition of MDEA (BPMA/MDEA ratio=½ molar) (MDEA=N-methyl-diethanolamine).

In a first series of experiments (FIG. 2), the results below were obtained. UV-PT stands for the maximum temperature attained in the course of the individual polymerizations.

| Chain-transfer agent | UV-PT | |
|---|---|---|
| content of polymeric PI | T [° C.] | t [min] |
| 10% Pentaerythritol | 56.03 | 78.50 |
| tetrathioglycolate | | |
| 8% Pentaerythritol | 57.12 | 82.67 |
| tetrathioglycolate | | |
| 5% Pentaerythritol | 53.25 | 94.33 |
| tetrathioglycolate | | |
| 2% Pentaerythritol | 49.30 | 108.83 |
| tetrathioglycolate | | |
| 8% Ethylhexyl | 60.25 | 89.50 |
| thioglycolate | | |

From FIG. 2 in conjunction with the values shown above it is apparent that as the chain-transfer agent content goes up, and hence as the molecular weight drops, there is an acceleration of the reaction.

In a second series of experiments (FIG. 3), the following results were obtained:

| Chain-transfer agent | UV-PT | |
|---|---|---|
| content of polymeric PI | T [° C.] | t [min] |
| 10% Pentaerythritol | 73.22 | 12.00 |
| tetrathioglycolate | | |
| 8% Pentaerythritol | 75.35 | 11.50 |
| tetrathioglycolate | | |
| 5% Pentaerythritol | 76.25 | 9.67 |
| tetrathioglycolate | | |
| 2% Pentaerythritol | 77.16 | 10.33 |
| tetrathioglycolate | | |
| 8% Ethylhexyl | 84.08 | 8.00 |
| thioglycolate | | |

It can be seen that, when MDEA is added, the polymerization is accelerated overall to a considerable degree.

1. A (meth)acrylate polymer, obtained by a process comprising polymerizing a mixture comprising
a) 0.1 to 99.9% by weight of at least one (meth)acrylate of (I) 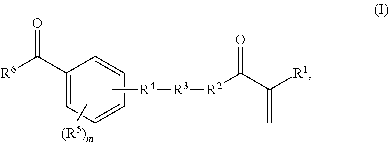
wherein
R¹ is hydrogen or methyl,
R² is oxygen or NH,
R³ is a radical of formula II 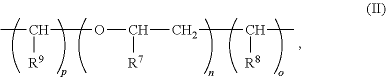
wherein
R⁷, R⁸, and R⁹ independently of one another are hydrogen or methyl,
n is an integer from zero to two hundred,
o and p independently of one another are an integer from zero to two, and, if the sum of n and o and p is zero, R³ is a bond,
R⁴ is a bond, oxygen, NH, O—CO—O, HN—CO—O, HN—CO—NH, or sulphur;
R⁵ is hydrogen, halogen, or a radical which has one to 20 carbon atoms and is optionally substituted by at least one selected for the group consisting of oxygen, nitrogen, and sulphur,
m is an integer from one to five, and
R⁶ is an aryl or heterocyclyl radical,
and
b) 99.9% to 0.1% by weight of one or a plurality of ethylenically unsaturated monomers which are different from a) and are copolymerizable with a),
wherein the components a) and b) together making 100% by weight of polymerizable constituents of the mixture, and
wherein the (meth)acrylate polymer has a weight-average molecular weight MW in a range from greater than or equal to 1000 g/mol to less than or equal to 50 000 g/mol, MW being measured by gel permeation chromatography against polymethyl methacrylate standards.

2. The polymer of claim 1, wherein R¹ is methyl.

3. The polymer of claim 1, wherein R² is oxygen.

4. The polymer of claim 1, wherein R⁴ is a bond.

5. The polymer of claim 1, wherein p=o=zero and n is an integer between 1 and 20.

6. The polymer of claim 1, wherein R⁷ is hydrogen.

7. The polymer of claim 1, wherein p=o=n=zero.

8. The polymer of claim 1, wherein all radicals R⁵ are hydrogen.

9. The polymer of claim 1, wherein R⁶ is phenyl.

10. The polymer of claim 1, wherein component b) is at least one (meth)acrylate monomer.

11. The polymer of claim 10, wherein component b) is methyl methacrylate.

12. The polymer of claim 10, wherein b) is at least one (meth)acrylate having 3 to 5 carbon atoms in the ester group.

13. The polymer of claim 10, wherein b) is butyl methacrylate.

14. The polymer of claim 10, wherein b) is a mixture of monomers comprising methyl methacrylate and n-butyl methacrylate.

15. The polymer claim 1, wherein it is obtained by polymerization in the presence of a chain-transfer agent.

16. The polymer of claim 15, wherein the chain-transfer agent comprises at least one selected from the group consisting of 2-ethylhexyl thioglycolate and pentaerythritol tetrathioglycolate, and is present in an amount of 0.05% to 5% by weight, based on a total mass of components a) and b).

17. The polymer of claim 1, having a weight-average molecular weight MW in a range from greater than or equal to 1000 g/mol to less than or equal to 10 000 g/mol.

18. The polymer of claim 1, having a weight-average molecular weight MW of less than 5000 g/mol.

19. The polymer according to of claim 1, obtained by a suspension polymerization or bead polymerization.

20. A UV initiator, comprising the polymer of claim 1, wherein the UV initiator is suitable for a polymerization reaction.

21. A solution in a reactive diluent, comprising the polymer of claim 1.

22. A polyfunctional (meth)acrylate, comprising the polymer of claim 1.

23. A 20 to 50 percent solution (w/w) in tripropylene glycol diacrylate, comprising the polymer of claim 1.

24. An additive to a UV-curable resin, comprising the polymer of claim 1.

25. A composition, comprising:
at least one accelerant selected from the group consisting of a low molecular weight amine, a polymeric amine, and a polymerizable amine; and
the additive of claim 1.

26. A printing ink, comprising the polymer of claim 1.

27. The printing ink of claim 26, comprising
A) 10%-40% by weight of at least one colorant;
B) 10%-50% by weight of at least one binder;
C1) 20%-80% by weight of at least one solvent or diluent;
C2) 0%-10% by weight customary, of at least one non-C1) auxiliary; and
D) 0.5%-25% by weight the polymer of claim 1, in the form of a polymer-bound UV initiator/crosslinker.
